(19) United States
(12) Patent Application Publication
(10) Pub. No.: US 2023/0278228 A1
(43) Pub. Date: Sep. 7, 2023

(54) SYSTEM AND METHOD FOR GENERATING A PRINTED COPY OF A PRINT FILE ACCORDING TO A DYNAMIC PRESSURE PROFILE

(71) Applicant: ConversionRobots Inc., San Francisco, CA (US)

(72) Inventors: Christopher Tosswill, San Francisco, CA (US); Sam Brewczynski, San Francisco, CA (US); Gene Kwak, San Francisco, CA (US)

(21) Appl. No.: 18/122,578

(22) Filed: Mar. 16, 2023

Related U.S. Application Data
(63) Continuation-in-part of application No. 18/100,425, filed on Jan. 23, 2023.
Application No. 18/100,425 is a continuation of application No. 17/574,341, filed on Jan. 12, 2022, now Pat. No. 11,587,275.
Application No. 17/574,341 is a continuation of application No. 17/026,126, filed on Sep. 18, 2020, now Pat. No. 11,257,267.
(60) Provisional application No. 63/321,500, filed on Mar. 18, 2022.
(60) Provisional application No. 62/902,246, filed on Sep. 18, 2019.

(51) Int. Cl. B25J 11/00; G06T 11/60; G06F 40/109; G06V 30/32; G06V 30/413; G06V 10/82; G06V 10/764; G06V 10/44

(52) U.S. Cl. CPC B25J 11/00; G06T 11/60; B25J 11/0005; G06F 40/109; G06V 30/347; G06V 30/413; G06V 10/82; G06V 10/764; G06V 10/44

(57) ABSTRACT

One variation of a method includes accessing a print file including a set of vector coordinates defining motion of a writing instrument on a surface for printing a string in a typeface corresponding to a user handwriting profile. The method further includes, during a print period: manipulating the writing instrument on the surface according to the set of vector coordinates to generate a printed copy of the string; regulating pressure applied by the writing instrument to the surface according to a pressure profile; and accessing a feed of images of the surface. The method further includes, during the print period: detecting a character defect of a defect type in a set of printed characters, in the printed copy, based on features extracted from an image in the feed of images; selecting a recovery mode configured to mitigate the defect type; and updating the pressure profile according to the recovery mode.

### CROSS-REFERENCE TO RELATED APPLICATIONS

This application claims the benefit of U.S. Provisional Application No. 63/321,500, filed on 18 Mar. 2022, which is incorporated in its entirety by this reference.

This application is a continuation-in-part of U.S. patent application Ser. No. 18/100,425, filed on 23 Jan. 2023, which is a continuation of U.S. patent application Ser. No. 17/574,341, filed on 12 Jan. 2022, which is a continuation of U.S. patent application Ser. No. 17/026,126, filed on 18 Sep. 2020, which claims the benefit of U.S. Provisional Application No. 62/902,246, filed on 18 Sep. 2019, each of which is incorporated in its entirety by this reference.

### TECHNICAL FIELD

This invention relates generally to the field of printing and more specifically to a new and useful system and method for autonomously regulating pressure applied on a writing surface by a writing instrument in the field of printing.

### BRIEF DESCRIPTION OF THE FIGURES

FIG. 1 is a flowchart representation of a method; and

FIG. 2 is a flowchart representation of one variation of the method.

### DESCRIPTION OF THE EMBODIMENTS

The following description of embodiments of the invention is not intended to limit the invention to these embodiments but rather to enable a person skilled in the art to make and use this invention. Variations, configurations, implementations, example implementations, and examples described herein are optional and are not exclusive to the variations, configurations, implementations, example implementations, and examples they describe. The invention described herein can include any and all permutations of these variations, configurations, implementations, example implementations, and examples.

### 1. Method

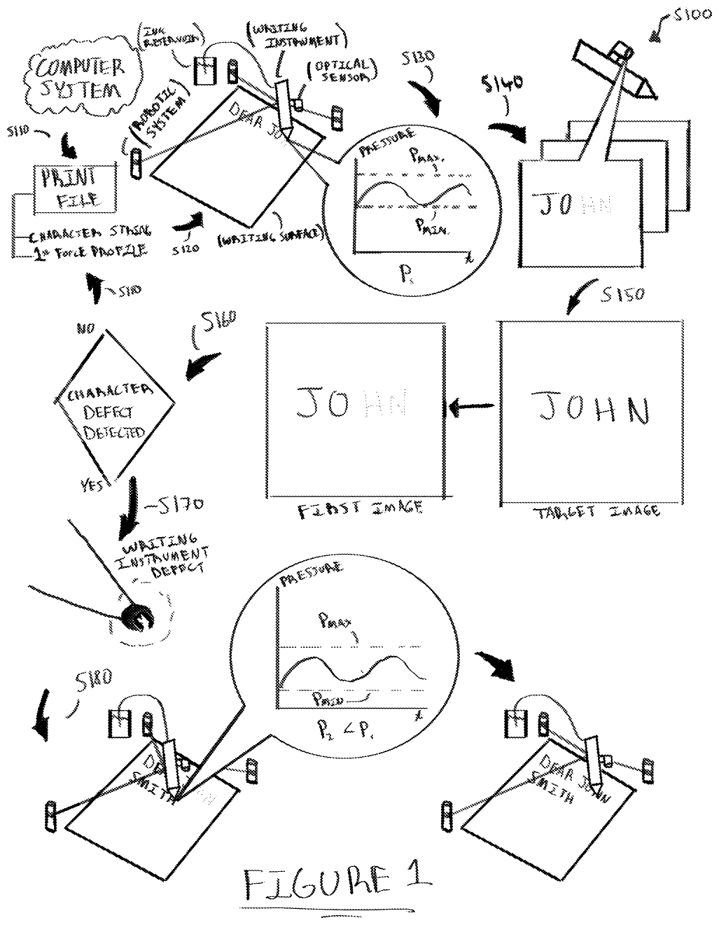

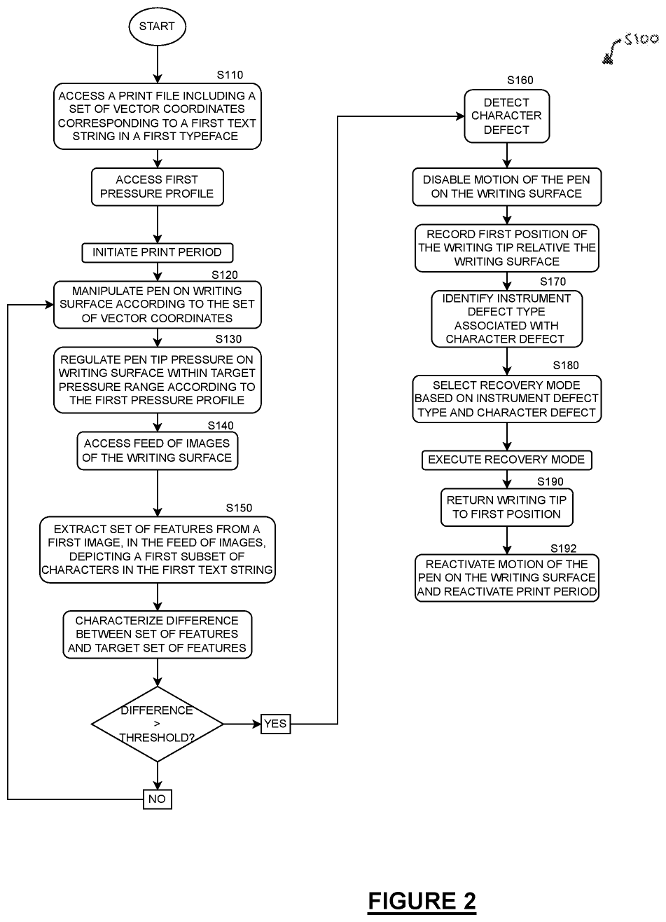

As shown in FIGS. 1 and 2, a method S100 includes, at a first time, accessing a first print file: including a first set of vector coordinates defining motion of a writing instrument on a writing surface to print a first character string in a first typeface corresponding to a handwriting profile of a user; and defining a first pressure profile corresponding to the handwriting profile in Block S110. The method S100 further includes, during a first print period for the first print file: manipulating the writing instrument on the writing surface according to the first set of vector coordinates to generate a printed copy of the first character string according to the first typeface in Block S120; regulating a pressure applied to the writing surface by a writing tip of the writing instrument within a target pressure range, defined by the writing instrument, according to the first pressure profile in Block S130; and accessing a feed of images of the writing surface captured by an optical sensor arranged over the writing surface in Block S140.

The method S100 further includes, during a first control period within the first print period: extracting a first set of features from a first image, in the feed of images, depicting a region of the writing surface corresponding to a first set of printed characters in the printed copy in Block S150; characterizing a difference between the first set of features and a target set of features corresponding to the first set of printed characters; and, in response to the difference exceeding a threshold difference, detecting a first character defect in the first set of printed characters in Block S160.

Furthermore, the method S100 includes, in response to detecting the first character defect: disabling motion of the writing instrument on the writing surface; recording a first position of the writing tip relative the writing surface; identifying an instrument defect type, in a set of instrument defect types, associated with the first character defect in Block S110; in response to the first character defect corresponding to a first instrument defect type, in the set of instrument defect types, selecting a first recovery mode, in a set of recovery modes, configured to mitigate instrument failure associated with the first instrument defect type and rectify the first character defect in the first set of printed characters in Block S180; updating the first pressure profile based on the first instrument defect type and according to the first recovery mode; and executing the first recovery mode.

The method S100 further includes, in response to confirming execution of the first recovery mode: returning the writing tip to the first position in Block S190; and reactivating motion of the writing instrument on the writing surface in Block S192.

### 2. Applications

Generally, Blocks of the method S100 can be executed by a computer system (e.g., a local computer system, a controller) in combination with a robotic system (e.g., a single-point printer) to: generate printed copies of a print file to reproduce a character string in a single-line typeface—that exhibits spatial and geometric glyph variations analogous to a user's authentic handwriting—on a writing surface (e.g., on physical paper or another physical surface); continuously (e.g., semi-continuously) supply ink to a writing instrument (e.g., a ball-point pen)—configured to deposit ink onto the writing surface according to the print file—from an external ink reservoir coupled to the writing instrument (e.g., via capillary action, via siphon action); and regulate tip pressure of the writing instrument on the writing surface within a target pressure range—such as defining a minimum tip pressure and a maximum tip pressure—and/or according to a dynamic pressure profile (e.g., defining change in tip pressure according to position on the writing surface) defined for the printed copy of the print file.

Therefore, by continuously supplying ink to the writing instrument from the external ink reservoir, the computer system and/or the robotic system (hereinafter “the system”) can: minimize downtime (e.g., breaks in printing) by eliminating the need to manually replace ink loaded in the writing instrument during printing periods; and reduce waste by extending longevity of the writing instrument. Furthermore, by regulating tip pressure within the target pressure range—defining a maximum tip pressure and a minimum tip pressure—the system can: minimize wear and tear exhibited by various components of the writing instrument (e.g., the writing tip, the ball) by maintaining tip pressure below the maximum pressure, thereby reducing downtime due to instrument failure (e.g., worn pen tip and/or ball); and enable generation of physical marks or grooves (e.g., of varying depths) in the writing surface by the writing instrument—such that the printed copy resembles authentic human handwriting on paper—and precise distribution of ink into these grooves by varying tip pressure according to a pressure profile and/or within a target pressure range defined by the print file. Further, by varying tip pressure within the target pressure range according to the dynamic pressure profile, the system can introduce glyph and/or character variability (e.g., within reasonable bounds) matched to the handwriting of the user.

Furthermore, the system can execute Blocks of the method S100 to: detect character defects—such as fading characters, ink trails between words or characters, and/or inconsistent ink application within characters—in glyphs or characters printed on the writing surface based on optical features extracted from images of the writing surface; identify instrument defect types (e.g., worn pen tip, damaged ball-point, instrument calibration error) associated with these detected character defects; and selectively implement a recovery mode based on the character defect and/or the instrument defect type and configured to both mitigate the instrument defect type—such as by replacing a worn pen tip and/or by loading a particular pressure profile (e.g., configured to extend life of the worn pen tip) onto the robotic system—and rectify the character defects on the writing surface while maintaining authenticity of a user's handwriting in the printed copy of the character string.

For example, the system can receive a print file including a first text string and a first typeface. During a print period, in response to receiving the print file, the system can: manipulate a writing instrument (e.g., according to a set of vector coordinates matched to the first text string and the first typeface)—arranged over a writing surface and including a writing tip and a ball-point arranged within the writing tip—to generate a printed copy of the first text string according to the print file; apply varying degrees of pressure—within a target pressure range—to the writing surface by the writing tip according to a pressure profile defined for the print file, such that the printed copy closely resemble characteristics of human handwriting; access a feed of images captured by an optical sensor arranged over the writing surface; and periodically (e.g., continuously, semi-continuously, pseudo-randomly) scan images, in the feed of images, during the print period to extract spatial features (e.g., endpoints, inflections points, character height, width, aspect ratio, curvature) from characters represented in these images.

Then, in response to a first set of spatial features, extracted from a first image, in the feed of images, depicting a first subset of characters in the first text string, deviating from a target set of spatial features defined for the first subset of characters, the system can: detect a character defect (e.g., inconsistent ink distribution, ink blotches, smeared characters) present in the printed copy in the first subset of characters; deactivate motion of the writing instrument and record a first position of the writing instrument relative the writing surface; interpret an instrument defect type for the writing instrument (e.g., worn pen tip, worn roller ball, uncalibrated instrument position), from a set of instrument defect types, corresponding to the character defect; and select a recovery mode, from a set of recovery modes, to mitigate instrument failure associated with the instrument defect type and rectify the character defect in the printed copy (e.g., by tracing over defected characters, scribbling over defected characters, white-out defected characters). Upon confirmation of execution of the selected recovery mode, the system can: return the writing instrument to the first position; and reactivate motion of the writing instrument on the writing surface.

In this example, the system can select and/or execute a recovery mode including: an instrument recovery mode configured to reduce instrument failure associated with a particular instrument defect type, such as by replacing a writing tip or ball-joint, scribbling in a corner of the writing surface to promote rotation of the ball-joint, and/or loading a replacement pressure profile configured to reduce wear on the writing instrument while maintaining authenticity of human handwriting; and a printing recovery mode configured to rectify instances of character defects, such as by retracing over a defective character, crossing out a defective character, and/or applying white out to a defective character. The system can therefore implement these recovery modes to output printed copies of the print file containing indicia (e.g., scribbles, white out, re-traced characters, variations in character depth on the writing surface) that closely resemble characteristics of human handwriting during the handwriting process.

The system can therefore execute Blocks of the method S100 to: extend shelf life of the writing instrument by regulating tip pressure of the writing tip against the writing surface within the target pressure range; generate printed copies of text files that mimic characteristics of human handwriting by varying tip pressure—according to a particular pressure profile (e.g., matched to a user's handwriting and/or configured to reduce instrument failure)—within this target pressure range; implement recovery modes responsive to detecting character defects in these printed copies configured to resemble characteristics of human handwriting; and improve efficiency of the robotic system, such as by reducing downtime due to instrument failure, thereby enabling the system to output more copies in less time, reducing waste and costs associated with the writing instrument (e.g., ball-point pen) by eliminating the need to periodically refill ink reserves within the writing instrument, and extending shelf life of components (e.g., pen tip, roller ball) for the writing instrument necessary to generate copies of printed text.

### 3. Robotic System

As shown in FIG. 1, a robotic system can include a writing instrument (e.g., a ballpoint pen) including: a writing tip configured to contact a writing surface (e.g., physical paper) arranged below the writing instrument; and a rotatable ball (or “roller ball”) arranged within the writing tip and configured to distribute ink onto the writing surface. The robotic system can also include: an ink reservoir fluidly coupled to the roller ball of the writing instrument and configured to supply (e.g., continuously, semi-continuously, pseudo-randomly) ink to the roller ball for distributing on the writing surface; and an optical sensor (e.g., a camera) facing the writing surface and configured to capture images of the writing surface to enable detection of character defects printed on the writing surface.

The robotic system can further include a controller configured to: receive a print file (e.g., from the computer system); coordinate motion of the writing instrument to generate a printed copy of the print file that mimics handwriting of a particular user; detect character defects in the printed copy based on images of the writing surface captured by the optical sensor; and selectively implement a recovery mode configured to mitigate future instances of character defects and rectify detected character defects on the writing surface.

In one implementation, the robotic system is configured to introduce variability between glyphs, characters, or words of a single print file or between copies of a single print file by mechanically varying a pressure (or “tip pressure”) applied by the writing tip on the writing surface. The robotic system can define variability bounds such that an amount of variability introduced is within reasonable bounds and therefore the printed copies of the text file match the handwriting of the user. For example, the robotic system can vary tip pressure, within a target pressure range, to generate variance within the printed copy—such as by varying the thickness and opacity of the lines segments of each glyph—of the print file (e.g., with no two instances of a single character appearing exactly the same).

### 3.1 Generating Handwriting Vectors

As described in U.S. patent application Ser. No. 17/026,126, filed on 18 Sep. 2020, which is incorporated in its entirety by this reference, the robotic system can be configured to receive a print file from the computer system. For example, during a first time period, the system can: access a handwriting sample including a set of user glyphs handwritten by a user and representing a set of characters; for each character in the set of characters, identify a subset of user glyphs, in the handwriting sample, corresponding to the character; characterize variability of a set of spatial features across the subset of user glyphs; store variability of a set of spatial features across the subset of user glyphs in a character container, in a set of character containers, corresponding to the character; and compile the set of character containers into a handwriting model associated with the user. Additionally, the system can, during a second period succeeding the first period: access a text string including a combination of characters in the set of characters; insert a set of variability parameters, for each instance of each character in the text string, into the handwriting model to generate a synthetic glyph, in a set of synthetic glyphs, representing the character; and assemble the set of synthetic glyphs into a print file, each synthetic glyph in the set of synthetic glyphs unique to each other synthetic glyph in the set of synthetic glyphs.

### 3.2 Optical Sensor

The system can include an optical sensor: arranged over the writing surface; and configured to capture images of the writing surface during a print period of the system. The system can: capture images of the writing surface during a print period; offload the images captured by the optical sensor, such as to a local or remote database; and extract spatial features from regions in the images corresponding to characters printed on the writing surface by the writing instrument.

For example, the system can: access a first image of the writing surface from a feed of images captured by the optical sensor during a print period; isolate a region in the first image corresponding to a first character printed on the writing surface by the writing instrument; and extract a first set of spatial features (e.g., start point position, end point position, change point position, character height, character width, maximum line thickness, minimum line thickness, maximum line opacity, minimum line opacity, line segment length, total character path length, kerning with respect to adjacent letters, negative space of closed areas) representative of the first character. The system can then repeat this process for each instance of characters in a text string printed on the writing surface.

In one implementation, the optical sensor can capture a continuous feed of images to the print period to continuously extract spatial features of characters as they are printed on the writing surface in order to readily identify defects on the writing surface. Additionally and/or alternatively, in another implementation, the optical sensor can capture a single image of the writing surface after completion of the print period. The system can therefore periodically extract spatial features of the characters printed on the writing surface to identify defects and initiate a recovery mode to edit the writing surface in response to detecting defects on the writing surface.

### 3.3 Continuous Pen and Ink Reservoir

The robotic system can include an external ink reservoir coupled to the writing instrument and configured to continuously supply the writing instrument with an ink material. For example, the robotic system can include: a ball-point pen including a writing tip (e.g., a ball-point pen tip) and a roller ball arranged within the writing tip; and an ink reservoir located externally from the writing instrument and fluidly coupled to the roller ball via a set of conduits (e.g., a set of tubes) configured to transfer ink material from within the ink reservoir to the roller ball via capillary action. Alternatively, in another example, the robotic system can be configured to transfer ink from the ink reservoir to the roller ball via siphon action. Therefore, the system can: reduce waste and costs associated with the writing instrument by reducing frequency of cycling through new writing instruments; and reduce down time of the system by continuously supplying ink to the writing instrument without interruption of the printing process.

In one variation, the system can include a depth sensor coupled to the ink reservoir and configured to monitor levels of ink material within the ink reservoir. The system can therefore monitor the amount of ink remaining within the ink reservoir and alert a user in a timely manner to refill the reservoir without halting the printing process. For example, the system can periodically access a set of depth values from the depth sensor (e.g., during and/or after a print period); and generate an alert or prompt instructing a user to fill the ink reservoir with ink material in response to the first set of depth values failing below a depth value threshold.

Additionally and/or alternatively, in another variation, the system can predict ink levels within the ink reservoir based on durations of printing periods. The system can then serve a prompt to users at regular time intervals to fill the ink reservoir in order to eliminate interrupting of the printing process. For example, the system can, during a print period: access a first print file including a first text string and a first pressure profile; manipulate the writing instrument to engage the writing surface in order to generate a printed copy of the first text string according to the first pressure profile over a first duration of time in the print period; predict a first ink level at a first time following termination of the first duration of time; and generate a prompt instructing a user to fill the ink reservoir with ink in response to the first ink level falling below an ink level threshold.

In yet another implementation, the system can adjust the flow rate of the ink as it is transferred from the ink reservoir to the writing instrument. In particular, the system can adjust the flow rate of the ink to replicate ink distribution of different writing instrument types (e.g., fountain pens, ball point pens) on a writing surface in order to print characters exhibiting characteristics that resemble human handwriting. For example, the system can apply a higher flow rate during printing of the greeting section to print text resembling characteristics of human handwriting utilizing a fountain pen and apply a lower flow rate during printing of a body section to print text resembling characteristics of human handwriting utilizing a ball point pen.

### 3.4 Dynamic Pressure

Generally, the system can: access a print file including a first text string and a first pressure profile; during a first print period, manipulate a writing instrument to generate a printed copy of the first text string in accordance with the first pressure profile; and regulate a pressure of the writing instrument on the writing surface within a target pressure range according to a particular pressure profile during the first print period to extend shelf life of the writing instrument and generate a printed copy of the first text string exhibiting characteristics closely resembling human handwriting.

### 3.4.1 Dynamic Pressure: Extending Shelf Life

In one implementation, the system can adjust the first pressure profile in order to vary pressure during a print period in order to extend shelf life of the writing instrument. In this implementation, extensive pressure applied during the print period may result in malfunction of a ball point tip of the writing instrument. Alternatively, diminutive pressure applied during the print period may result in reduced visibility of the characters printed on the writing surface. The system can therefore adjust the first pressure profile according to a target pressure range to reduce forces experienced by the tip of the writing instrument during the print period to extend shelf life of the writing instrument while maintaining visibility of characters printed on the writing surface.

For example, the system can, at a first time, access a first print file including a first text string, a second text string, and a first pressure profile, the first text string corresponding to a greeting section of the first print file and the second text string corresponding to a body section of the first print file. Additionally, the system can, during a first duration of time in a print period, manipulate the writing instrument to engage the writing surface to generate a printed copy of the first text string according to the first pressure profile during the first duration of time. Furthermore, the system can, during a second duration of time succeeding the first duration of time in the print period: attenuate the first pressure profile to a second pressure profile according to a target pressure range; and manipulate the writing instrument to engage the writing surface to generate a printed copy of the second text string according to the second pressure profile during the second duration of time. Therefore, by varying pressure experienced by the tip of the writing instrument during the print period, the shelf life of the writing instrument can be extended.

In another example of this implementation, the system can: access a first print file including a first text string and a pressure profile; adjust the writing instrument to a first position proximal a first edge on the writing surface; over a first time period, manipulate the writing instrument toward a second edge on the writing surface opposite the first edge; generate a printed copy of the first text string laterally along the writing surface; and attenuate the pressure profile according to a target pressure range during the first time period to reduce pressure applied to the writing surface as the writing instrument moves toward the second edge of the writing surface.

In another implementation, the system can: access a first feed of images of the writing surface captured by an optical sensor; extract spatial features from regions in the first feed of images corresponding to characters printed on the writing surface; detect character defects (e.g., ink blotches, smearing) for the characters based on the spatial features extracted; interpret instrument defect types (e.g., worn tip, broken ball point) for components of the writing instrument based on the character defects and the spatial features extracted; and modify the pressure profile to extend shelf life in response to interpreting defects for the writing instrument.

For example, the system can: at a first time, access a print file including a first text string and a first pressure profile. Additionally, the system can, during a first printing period: manipulate the writing instrument to generate a printed copy of the text string on a writing surface according to the first pressure profile; and access a first feed of images of the writing surface captured by an optical sensor coupled to the writing instrument. Furthermore, the system can, during a control period within the first printing period: extract spatial features from regions in the first feed of images corresponding to characters printed on the writing surface; detect character defects (e.g., ink blotches, smearing) for characters printed on the writing surface; interpret an instrument defect type for the writing instrument (e.g., worn tip, broken ball point) from a set of instrument defect types, based on the character defects and the spatial features extracted from the first feed of images; and attenuate the first pressure profile according to a target pressure range in response to interpreting the instrument defect type and in order to extend shelf life of the writing instrument.

### 3.4.2 Dynamic Pressure: Authentic Human Handwriting

In one implementation, the system can adjust the first pressure profile in order to vary pressure during a print period in order to generate copies of text that exhibit characteristics closely resembling human handwriting. The system can introduce variability in pressure to replicate characteristics of human handwriting, such as the varying application of pressure when formulating handwritten characters on a writing surface. In this implementation, the system receives a print file including: a text string; a handwriting vector including instructions for generating a written copy of the text string according to predefined characteristics for a set of user glyphs (e.g., endpoints, inflection points, height, depth, curvature); and a pressure profile matched to the handwriting vector corresponding to pressure applied to the writing surface by the writing instrument to generate the text string in accordance with the handwriting vector. The system can then implement a variability function applied to the pressure profile to generate variations of pressure applied to the writing surface by the writing instrument within a target pressure range during the print period. As a result, each character printed on the writing surface by the writing instrument can be generated with a varying degree of force, thereby generating printed copies of the text string that exhibit characteristics closely resembling human handwriting.

In another implementation, the system can continuously modify the pressure profile according to a target pressure range based on a combination of extending shelf life of the writing instrument and generating copies of the text string that closely resemble human handwriting.

### 4. Defect Detection

In one implementation, the system can: detect character defects in characters printed on the writing surface based on optical features recorded by the optical sensor; interpret instrument failure of a particular instrument defect type based on these character defects; and select a recovery mode—configured to mitigate instrument failure associated with the instrument defect type and rectify detected character defects on the writing surface—based on the character defects and/or instrument defect type.

For example, the system can: access a first image of the writing surface from a first feed of images captured by an optical sensor arranged over the writing surface; isolate a region in the first image corresponding to a first string of characters printed on the writing surface; extract a first set of spatial features (e.g., endpoints, inflections points, character height, width, aspect ratio, curvature) from the region in the first image corresponding to the first string of characters printed on the writing surface; and characterize a difference between the first set of spatial features and a target set of spatial features defined for the print file. Furthermore, in response to the difference exceeding a threshold difference, the system can: flag the first string of characters; detect a character defect (e.g., high-opacity character, inconsistent ink transfer, ink blotches, smearing) in the first string of characters based on the difference; and select a recovery mode, from a set of recovery modes, based on the detected character defect to rectify the character defect (e.g., scribbling over character defects, tracing over characters) for the first string of characters printed on the writing surface.

Further, the system can interpret an instrument defect type associated with instrument failure (e.g., failure of the writing instrument) based on these detected character defects.

In particular, in the preceding example, in response to detecting a first character defect on the writing surface, the system can: correlate the first character defect and/or the first set of spatial features with a set of instrument defect types associated with instrument failure; and, in response to a first instrument defect type (e.g., broken writing instrument tip, defective pen ball, excessive pressure applied to the tip), in the set of instrument defect types, exceeding a threshold defect correlation, the system can: flag a particular component of the writing instrument associated with the first instrument defect type; attenuate the pressure profile according to a target pressure profile in order to preserve shelf life of the writing instrument; and generate a prompt to inspect the particular component of the writing instrument for replacement or repair.

Additionally and/or alternatively, in another implementation, the system can include: a writing instrument including a tip; and an optical sensor coupled to the writing instrument and configured to capture a feed of images of the tip of the writing instrument. The system can: access images of the tip captured by the optical sensor during the print period; extract spatial features from regions in the images corresponding to the tip of the writing instrument; and interpret instrument defects for the tip of the writing utensil based on the spatial features for the tip deviating from target spatial features.

Additionally and/or alternatively, in yet another implementation, the system can interpret an instrument defect type from a set of instrument defect types based on a set of defect metrics. The system can: extract spatial features from a first image corresponding to a string of characters printed on the writing surface; and interpret a calibration height defect and/or a tip pressure defect in response to detecting minimal kerning in the string of characters. Additionally and/or alternatively, the system can interpret a pressure defect and/or a ball point tip failure type in response to detecting minimum line opacity in the string of characters. The system can further detect absence of characters printed on the writing surface and generate a prompt for a user to inspect the writing instrument in response to detecting the absence of characters.

### 5. Defect Recovery Mode

In response to detecting character defects on the writing surface and/or interpreting a particular instrument defect type, the system can select a recovery mode configured to: mitigate instrument failure associated with a particular instrument defect type; and rectify detected character defects on the writing surface. In particular, the system can select a recovery mode configured to balance longevity (e.g., shelf life) of the writing instrument and generating printed copies exhibiting characteristics closely resembling human handwriting.

For example, the system can: access a first image of the writing surface from a first feed of images captured by an optical sensor arranged over the writing surface; isolate a region in the first image corresponding to a first string of characters printed on the writing surface; extract a first set of spatial features from the first image corresponding to the first string of characters printed on the writing surface; and characterize a difference between the first set of spatial features and a target set of spatial features defined for the print file. Additionally, the system can: detect a character defect (e.g., ink blotches, smearing) for a first character at a first location on the writing surface in response to the difference exceeding a difference threshold; and interpret an instrument defect type for the writing instrument (e.g., worn tip, broken ball point) from a set of instrument defect types based on the character defect detected defect for the first character and the first set of spatial features. Furthermore, the system can, select a recovery mode, from a set of recovery modes, in response to interpreting the instrument defect type configured to: rectify the character defects for the characters printed on the writing surface (e.g., scribbling over defects, tracing over defects); and attenuate a pressure profile according to a target pressure range to preserve shelf life of the writing instrument.

Therefore, the system can select and/or execute a recovery mode including: an instrument recovery mode configured to reduce instrument failure associated with a particular instrument defect type; and a printing recovery mode configured to rectify instances of character defects. In particular, the system can selectively implement instrument recovery modes such as: replacing a writing tip; replacing a ball-joint; recalibrating a position and/or height of the writing instrument; scribbling in a corner of the writing surface to promote rotation of the ball-joint; loading a replacement pressure profile configured to reduce wear on the writing instrument while maintaining authenticity of human handwriting; and/or loading a replacement pressure profile configured to reduce wear on the writing instrument while highlighting portions of text—such as by increasing tip pressure in a greeting or salutation while decreasing pressure in a body of text—that a user may initially view and perceive as human handwriting. The system can similarly selectively implement printing recovery modes such as: retracing over a defective character; crossing out a defective character; and/or applying white out to a defective character. The system can therefore implement these recovery mode to output printed copies of the print file containing indicia (e.g., scribbles, white out, re-traced characters, variations in character depth on the writing surface) that closely resemble characteristics of human handwriting during the handwriting process.

In one implementation, the system can: interpret character defects for characters printed on the writing surface based on optical features; detect line opacity exceeding a line opacity threshold for a first character in a set of characters on the writing surface; and manipulate the writing instrument to trace over the first character.

For example, the system can: access a first image of the writing surface from a first feed of images captured by an optical sensor arranged over the writing surface; extract a first set of spatial features from the first image corresponding to the first character printed on the writing surface; and interpret a first line opacity value for the first character. Furthermore, in response to the first line opacity value exceeding a threshold line opacity value associated with the first character, the system can then: interpret an opacity instrument defect type (e.g., diminished visibility of the printed character) for the first character at a first location on the writing surface; and manipulate the writing instrument to trace over the first character at the first location on the writing surface to remedy the instrument defect type printed on the writing surface.

In another implementation, the system can: interpret character defects for characters printed on the writing surface based on optical features; predict an instrument defect type for the writing instrument based on character defects interpreted for the characters printed on the writing surface; and manipulate a white-out pen on a first region containing the instrument defect type on the writing surface to cover the instrument defect type. The system can then proceed to manipulate the writing instrument to trace over the first region as described above to remedy the instrument defect type. In this implementation, excessive use of the writing instrument to rectify detected defects for characters printed on the writing surface is avoided, thereby extending shelf life of the pen while printing copies exhibiting characteristics resembling human handwriting.

For example, the system can: access a first image of the writing surface from a first feed of images captured by an optical sensor arranged over the writing surface; extract a first set of spatial features from the first image corresponding to a first string of characters printed on the writing surface; and characterize a difference between the first set of spatial features and a target set of spatial features defined for the print file. Furthermore, in response to the difference exceeding a threshold difference, the system can: interpret character defects (e.g., ink blotches, smearing) for the first string of characters printed on a first region on the writing surface; at a first time, manipulate a white-out pen over the first region on the writing surface to cover the first instrument defect type; and, at a second time succeeding the first time period, manipulate the writing instrument to trace the first string of characters over the first region covered by the white-out pen.

In yet another implementation, the system can: detect character defects for characters printed on the writing surface based on optical features; interpret an unknown instrument defect type for the writing instrument based on the character defects and the optical features; and generate a prompt to notify a user to inspect the writing instrument. For example, the system can: access a first image of the writing surface from a first feed of images captured by an optical sensor arranged over the writing surface; extract a first set of spatial features from the first image corresponding to a first string of characters printed on the writing surface; characterize a difference between the first set of spatial features and a target set of spatial features for the first string of characters defined by the print file; and, in response to the difference exceeding a threshold difference, detect character defects for the first string of characters. Furthermore, the system can: interpret an unknown instrument defect type for the writing instrument based on the character defects and the first set of spatial features; record a first position of the writing instrument at the first location proximal the writing surface; generate a prompt to inspect the first location on the writing surface and the writing instrument; and serve the prompt to a user associated with the robotic system (e.g., via a native application executing on the user's computing device, via email or text message).

### 6. Variations

In one implementation, the system can include: a writing instrument configured to engage a writing surface arranged beneath the writing instrument to generate a copy of a text string; and a pressure sensor—arranged underneath the writing surface—configured to read force values applied on the writing surface by the writing instrument. In this implementation, the system can predict instrument failure corresponding to a particular instrument defect type based on force values read by the pressure sensor during a print period. For example, the system can: access a print file including a first text string and a first pressure profile; manipulate the writing instrument to generate a printed copy of the first text string on the writing surface according to the first pressure profile; read a first set of pressure vales from the pressure sensor as the writing instrument is manipulated over the writing surface; and generate a first pressure image based on the first set of pressure values. The system can then, in response to the first pressure image deviating from a baseline pressure image, interpret an instrument defect type, from a set of instrument defect types, for the writing instrument. Furthermore, in response to detecting defects in the writing instrument, the system can attenuate the first pressure profile according to a target pressure range in order to extend shelf life of the writing instrument.

In another implementation, the system includes a writing instrument including: a tip; and a pressure sensor coupled to the tip and configured to read pressure values experienced by the tip when applying forces to the writing surface. In this implementation, the system can: predict malfunctions in the writing instrument based on a tip pressure profile deviating from a baseline tip pressure profile when generating printed copies on the writing surface; and, in response to the tip pressure profile deviating from the baseline tip pressure profile, adjust the pressure profile according to a target pressure range to preserve shelf life of the tip of the writing instrument.

The systems and methods described herein can be embodied and/or implemented at least in part as a machine configured to receive a computer-readable medium storing computer-readable instructions. The instructions can be executed by computer-executable components integrated with the application, applet, host, server, network, website, communication service, communication interface, hardware/firmware/software elements of a user computer or mobile device, wristband, smartphone, or any suitable combination thereof. Other systems and methods of the embodiment can be embodied and/or implemented at least in part as a machine configured to receive a computer-readable medium storing computer-readable instructions. The instructions can be executed by computer-executable components integrated by computer-executable components integrated with apparatuses and networks of the type described above. The computer-readable medium can be stored on any suitable computer readable media such as RAMs, ROMs, flash memory, EEPROMs, optical devices (CD or DVD), hard drives, floppy drives, or any suitable device. The computer-executable component can be a processor but any suitable dedicated hardware device can (alternatively or additionally) execute the instructions.

As a person skilled in the art will recognize from the previous detailed description and from the figures and claims, modifications and changes can be made to the embodiments of the invention without departing from the scope of this invention as defined in the following claims.

I claim:

1. A method comprising:
at a first time, accessing a print file comprising a set of vector coordinates, defining motion of a writing instrument on a writing surface for printing a character string in a typeface corresponding to a handwriting profile of a user, and defining a pressure profile corresponding to the handwriting profile;
during a print period for the print file:
manipulating the writing instrument on the writing surface according to the set of vector coordinates to generate a printed copy of the character string according to the typeface;
regulating a pressure, applied to the writing surface by a writing tip of the writing instrument, within a target pressure range according to the pressure profile; and
accessing a feed of images of the writing surface captured by an optical sensor arranged over the writing surface; and
during a control period within the print period:
extracting a set of features from a first image, in the feed of images, depicting a region of the writing surface corresponding to a set of printed characters in the printed copy;
characterizing a difference between the set of features and a target set of features corresponding to the set of printed characters;
in response to the difference exceeding a threshold difference, detecting a character defect in the set of printed characters; and
in response to detecting the character defect:
identifying an instrument defect type, in a set of instrument defect types, associated with the character defect;
in response to the character defect corresponding to an instrument defect type, in the set of instrument defect types, selecting a recovery mode, in a set of recovery modes, configured to mitigate the instrument defect type and rectify the character defect in the set of printed characters; and
updating the pressure profile according to the recovery mode.

2. The method of claim 1, further comprising, during the control period:
in response to detecting the character defect:
disabling motion of the writing instrument on the writing surface; and
recording a position of the writing tip relative the writing surface; and
in response to confirming execution of the recovery mode:
returning the writing tip to the position; and
reactivating motion of the writing instrument on the writing surface.
